(19) United States
(12) Patent Application Publication
(10) Pub. No.: US 2009/0025994 A1
(43) Pub. Date: Jan. 29, 2009

(54) TRUCK

(75) Inventors: Naoya Kakishita, Kanagawa (JP); Itsuhei Kori, Kanagawa (JP); Takafumi Hirase, Kanagawa (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kawasaki-shi, Kanagawa (JP)

(21) Appl. No.: 11/577,160

(22) PCT Filed: Oct. 13, 2004
(86) PCT No.: PCT/JP04/15054

§ 371 Date: Apr. 12, 2007

(51) Int. Cl. B60K 11/04; B62D 35/00

(52) U.S. Cl. 180/68.6; 296/181.5

(57) ABSTRACT

A truck 1 includes a cab 3 in which a driver's seat is provided, a van 5 provided rearward of the cab and serving as a load container, wheels 7a, 7b, 7c, and 7d, etc. These components are attached to frame members 9a, 9b, 9c, 9d, 9e, 9f, etc. An engine 13 is provided between the frame members 9a and 9b. A drive-force transmission apparatus which includes a clutch 15, a transmission 17, etc. is provided rearward of the engine 13 so as to transmit drive force from the engine 13 to the wheels (driven wheels 7b and 7d). A radiator 19 is provided forward of the engine 13 so as to cool the engine 13. A windbreaking plate 25 is provided above a portion of the engine 13 exposed from a gap 30 between the cab 3 and the van 5 so as to prevent a downward air flow 26 from hitting the engine 13 to thereby hinder the flow of radiator intake air 32.

### TECHNICAL FIELD

The present invention relates to a truck.

### BACKGROUND ART

Recently, the mainstream of motor-lorries such as trucks is a cab-over-type truck in which the bonnet is omitted in order to increase the load capacity of the van, which serves as a load container.

Because of the structure of having the bonnet omitted, such a cab-over-type truck carries the radiator, engine, etc. under the cab. Recently, the quantity of heat radiated by the radiator tends to increase due to an increased output of the engine, and the flow of cooling air within the engine compartment tends to deteriorate because the engine compartment is shielded in consideration of noise regulation.

In order to improve the flow of cooling air, in some cases, a separate fan or the like is provided within the engine compartment so as to suck and forcedly exhaust air within the engine compartment, as is known from, for example, the following publication.

Patent Document 1: Japanese Patent Application Laid-Open (kokai) No. 2002-36888

### DISCLOSURE OF THE INVENTION

### Problems to be Solved by the Invention

However, such a truck has problems of high cost as well as a problem of requiring a space necessary for providing a separate fan or the like.

The present invention has been accomplished in light of the above problems, and an object of the present invention is to provide a truck which can improve the engine cooling performance inexpensively.

### Means for Solving the Problems

In order to achieve the above-described object, according to a first aspect of the invention, there is provided a truck characterized by comprising a load container provided rearward of a cab and projecting upward from the cab; an engine provided under the cab; a radiator provided forward of the engine; and a windbreaking section provided between the cab and the load container.

The load container may be formed to have a width equal to or smaller than that of the cab, and the windbreaking section may be provided above the engine and formed to extend over a width approximately equal to the width of the cab.

The load container may be formed to have a width greater than that of the cab, and the windbreaking section may be provided above the engine across a center line of the engine with respect to a width direction of the truck and formed to extend over a width approximately equal to the width of the engine.

The windbreaking section may assume a plate-like shape generally extending horizontally.

The plate-shaped windbreaking section may assume the form of a flat plate horizontally extending in a width direction of the cab.

The plate-shaped windbreaking section may be bent such that the windbreaking section is upwardly convex at a central portion thereof in the width direction of the cab.

The plate-shaped windbreaking section may be curved such that the windbreaking section is upwardly convex.

Further, according to a second aspect of the invention, there is provided a truck characterized by comprising a load container provided rearward of a cab and projecting upward from the cab; an engine provided under the cab; a radiator provided forward of the engine; a drive-force transmission apparatus provided rearward of the engine; and a windbreaking section provided between the cab and the load container.

The load container may be formed to have a width equal to or smaller than that of the cab, and the windbreaking section may be provided above the drive-force transmission apparatus and formed to extend over a width approximately equal to the width of the cab.

The load container may be formed to have a width greater than that of the cab, and the windbreaking section may be provided above the drive-force transmission apparatus across a center line of the drive-force transmission apparatus with respect to a width direction of the truck and formed to extend over a width approximately equal to the width of the drive-force transmission apparatus.

The windbreaking section may assume a plate-like shape generally extending horizontally.

The plate-shaped windbreaking section may assume the form of a flat plate horizontally extending in a width direction of the cab.

The plate-shaped windbreaking section may be bent such that the windbreaking section is upwardly convex at a central portion thereof in the width direction of the cab.

The plate-shaped windbreaking section may be curved such that the windbreaking section is upwardly convex.

### EFFECTS OF THE INVENTION

According to the present invention, since a windbreaking plate is provided on the truck, the engine cooling performance can be readily improved at low cost. Accordingly, an engine of high output can be mounted on the truck.

### BRIEF DESCRIPTION OF THE DRAWINGS

FIG. 1 View showing a truck 1.

FIG. 2(a) View showing the truck 1.

FIG. 2(b) View showing the truck 1.

FIG. 2(c) View showing the truck 1.

FIG. 3 Graph showing the relation between the travel-direction length 29 of a windbreaking plate 25 and water temperature drop of a radiator 19.

FIG. 4 Perspective view showing a truck 45.

FIG. 5(a) View showing the truck 45.

FIG. 5(b) View showing the truck 45.

FIG. 5(c) View showing the truck 45.

FIG. 6(a) View showing a truck 61.

FIG. 6(b) View showing the truck 61.

FIG. 6(c) View showing the truck 61.

FIG. 7(a) View showing a truck 71.

FIG. 7(b) View showing the truck 71.

FIG. 7(c) View showing the truck 71.

FIG. 8(a) View showing the windbreaking plate 25 and a windbreaking plate 53.

FIG. 8(b) View showing the windbreaking plate 25 and the windbreaking plate 53.

FIG. 8(c) View showing the windbreaking plate 25 and the windbreaking plate 53.

### DESCRIPTION OF REFERENCE NUMERALS

1 . . . truck
3 . . . cab
5 . . . van
7a . . . wheel
9a . . . frame
13 . . . engine
15 . . . clutch
17 . . . transmission
19 . . . radiator
21 . . . cab width
23 . . . van width
25 . . . windbreaking plate
26 . . . downward air flow
27 . . . width
29 . . . travel-direction length
31 . . . stable region
32 . . . radiator intake air flow
49 . . . downward air flow
51 . . . side air flow
53 . . . windbreaking plate
55 . . . engine width

### BEST MODE FOR CARRYING OUT THE INVENTION

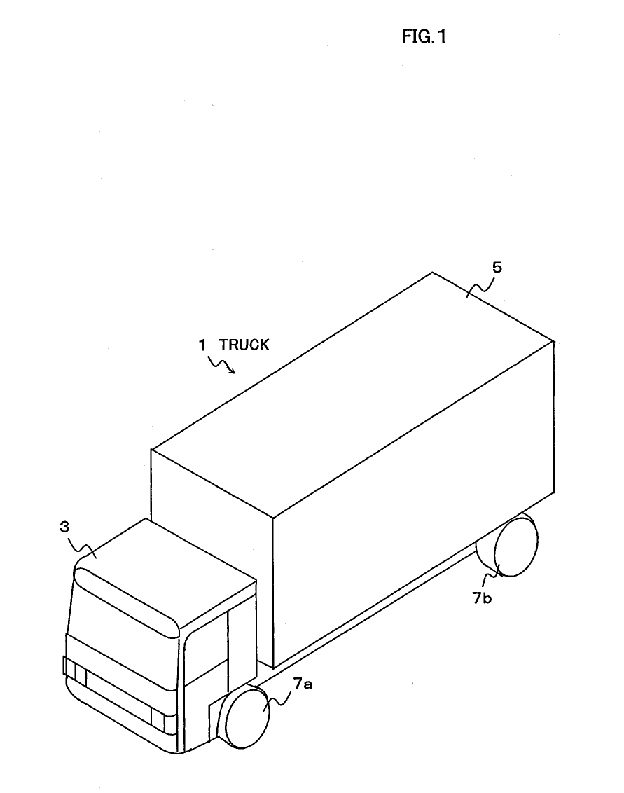

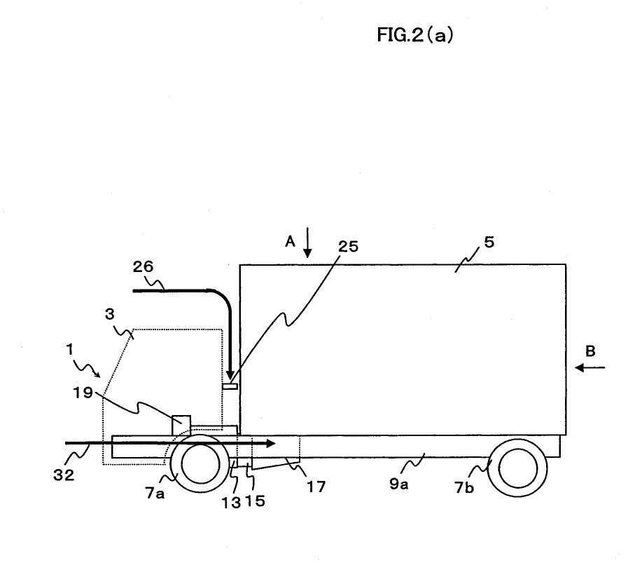

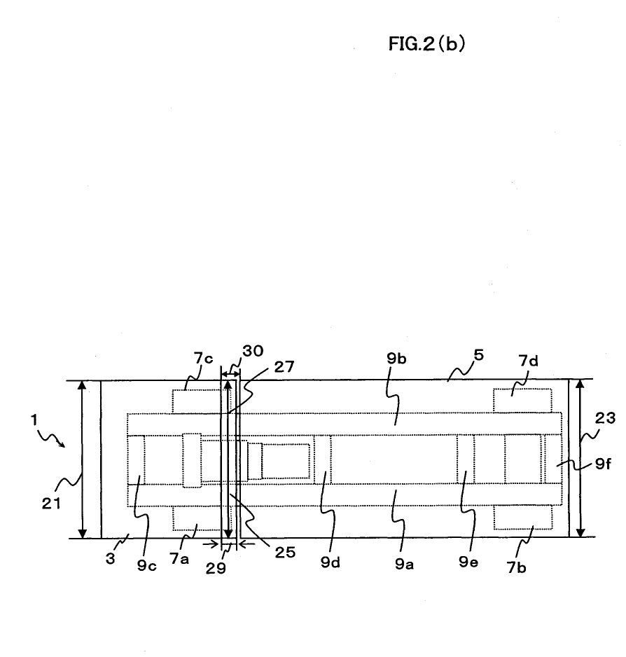

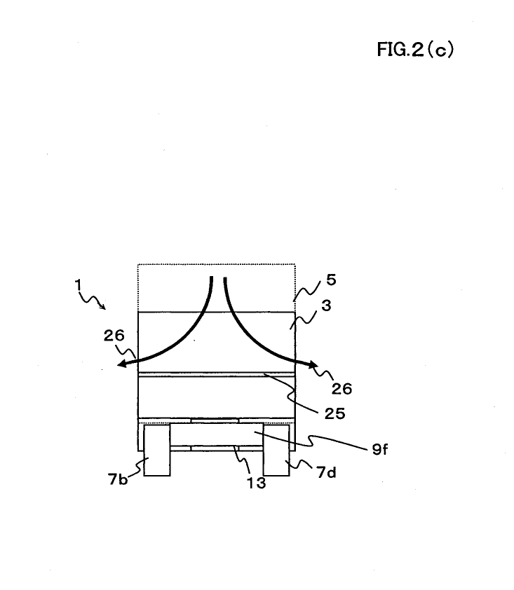

Preferred embodiments of the present invention will next be described in detail with reference to the accompanying drawings. FIGS. 1, 2(a), 2(b), and 2(c) show a truck 1 according to a first embodiment. FIG. 1 is a perspective view of the truck; FIG. 2(a) is a side view of the truck; FIG. 2(b) is a view of the truck as viewed in the direction of arrow A in FIG. 2(a); and FIG. 2(c) is a view of the truck as viewed in the direction of arrow B in FIG. 2(a).

As shown in FIGS. 1, 2(a), and 2(b), the truck 1 includes a cab 3 in which a driver's seat is provided; a van 5 provided rearward of the cab and serving as a load container; wheels 7a, 7b, 7c, and 7d; etc. These components are attached to frame members 9a, 9b, 9c, 9d, 9e, 9f, etc.

An engine 13, which serves as a motor, is provided between the frame members 9a and 9b. A drive-force transmission apparatus which includes a clutch 15, a transmission 17, etc. is provided rearward of the engine 13 so as to transmit drive force from the engine 13 to the wheels (driven wheels 7b and 7d). A radiator 19 is provided forward of the engine 13 so as to cool the engine 13.

The radiator 19 introduces air by use of an unillustrated fan or the like provided therein and cools cooling water inside the radiator by means of the introduced air.

Notably, the introduced air flows out of the rear side of the radiator 19, passes the space around the engine 13 and the drive-force transmission apparatus, and is exhausted to the outside of the truck. The continuous flow of air will be referred to as radiator intake air flow 32.

It is to be noted that a cab width 21 is made equal to a van width 23, or the van width 23 is made smaller than the cap width 21, so as to prevent generation of side air flows 51, which will be described later.

In the first embodiment, a portion of the engine 13 is exposed to a gap 30 between the cab 3 and the van 5. However, a windbreaking plate 25 (windbreaking section) is provided above the exposed portion.

As shown in FIGS. 2(a) and 2(c), during travel, a wind produced as a result of travel (travel wind) hits a portion of the van 5 higher than the cab 3, and produces a downward flow 26 of air, which flows through the gap 30 between the cab 3 and the van 5 and hits the exposed engine 13 to thereby increase the pressure in the vicinity of the engine 13.

The applicant of the present invention has confirmed that since the radiator intake air flow 32, which is the flow or air passing through the radiator 19, is exhausted to the space around the engine 13, if the pressure in the vicinity of the engine 13 increases, air encounters difficulty in flowing through that space, whereby there arise the problems of decreased quantity of air passing through the radiator 19 and deteriorated performance of cooling the engine 13.

In the first embodiment, the windbreaking plate 25 is provided on the rear surface of the cab 3. This prevents the downward air flow 26 from hitting the engine exposed to the gap 30 between the cab 3 and the van 5. Thus, an increase in the pressure in the vicinity of the engine 13 is prevented, whereby a decrease in the radiator intake air flow 32 can be prevented, along with deterioration in the engine cooling performance.

Although a width 27 of the windbreaking plate 25 is equal to the cab width 21, a length 29 of the windbreaking plate 25 in the travel direction is not necessarily required to be equal to the gap 30 between the cab 3 and the van 5.

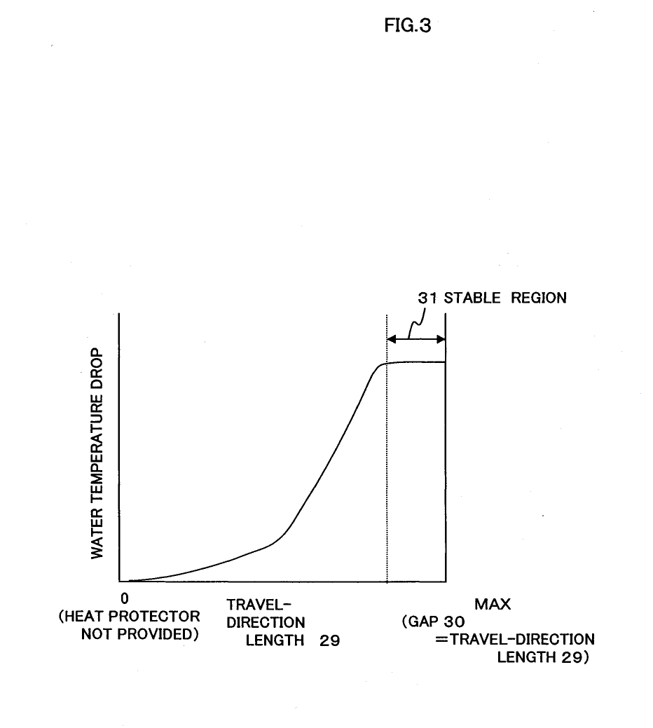

FIG. 3 is a graph showing the relation between the length 29 of the windbreaking plate 25 in the travel direction and drop in water temperature of the radiator 19 (quantity of air passing through the radiator).

As can be understood from FIG. 3, the travel-direction length 29 of the windbreaking plate 25 and drop in water temperature of the radiator 19 (quantity of air passing through the radiator) have a relation such that the water temperature drop increases with the travel-direction length 29, but, when the travel-direction length 29 exceeds a predetermined length, there appears a stable region 31 in which the water temperature drop does not change very much in spite of the increase in the travel-direction length 29.

Therefore, so long as the travel-direction length 29 falls within the stable region 31, the travel-direction length 29 is not necessarily required to be equal to the gap 30 between the cab 3 and the van 5.

Notably, the graph of FIG. 3 is obtained through experiments.

In the first embodiment, since the windbreaking plate 25 is provided on the rear surface of the cab 3 as described above, the performance of cooling the engine 13 can be readily improved at low cost. Therefore, an engine of high output can be mounted.

Next, a second embodiment will be described.

In the above-described truck 1, the van width 23 is equal to or smaller than the cab width 21. In some trucks, the van width is made greater than the cab width, in order to increase the load capacity of the van.

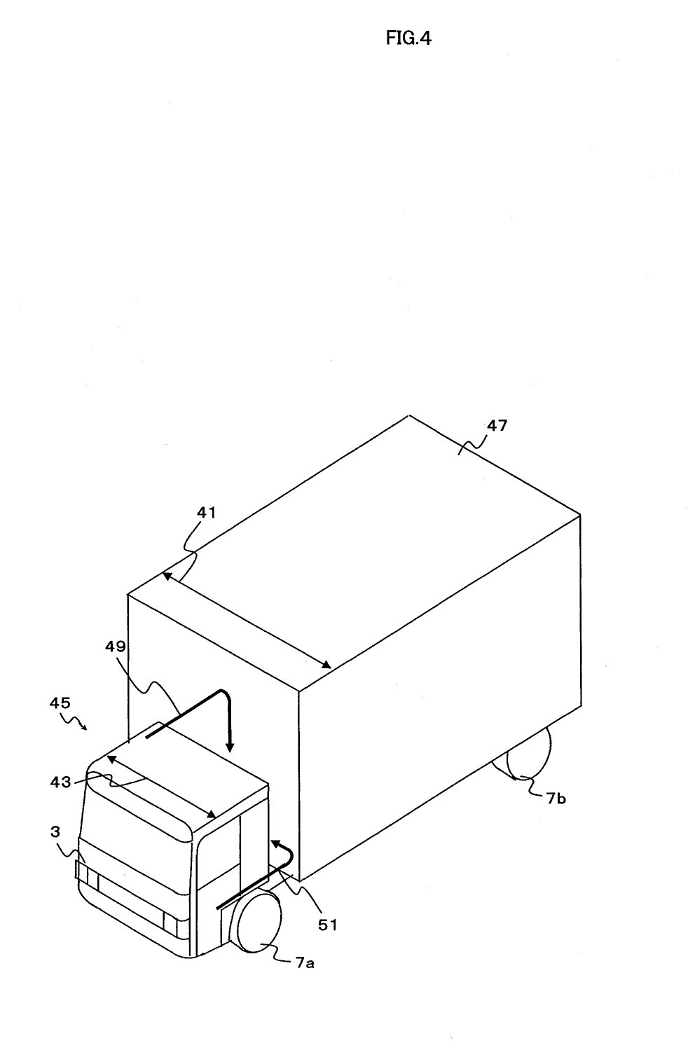

FIG. 4 is a perspective view of a truck 45 according to the second embodiment.

As shown in FIG. 4, the van width 41 is greater than the cab width 43.

In the case of such a truck 45, during travel, in addition to a downward air flow 49 generated by a travel wind hitting an upper projecting portion of a van 47, side air flows 51 are generated by travel winds hitting side projecting portions of the van 47.

After hitting the side projecting portions of the van 47, the side air flows 51 change their flow directions toward the engine 13, and hit the engine 13, which increases the pressure around the engine 13.

When the pressure around the engine 13 increases, the quantity of air passing through the radiator 19 decreases, and the performance of cooling the engine 13 deteriorates. That is, the applicant also confirmed that the performance of cooling the engine 13 deteriorates when the van width 41 is greater than the cab width 43.

Since the van width 41 is greater than the cab width 43 in the truck 45 according to the second embodiment, a windbreaking plate 53 which can prevent not only the downward air flow 49 but also the side airflows 51 is provided (the details of the windbreaking plate will be described later).

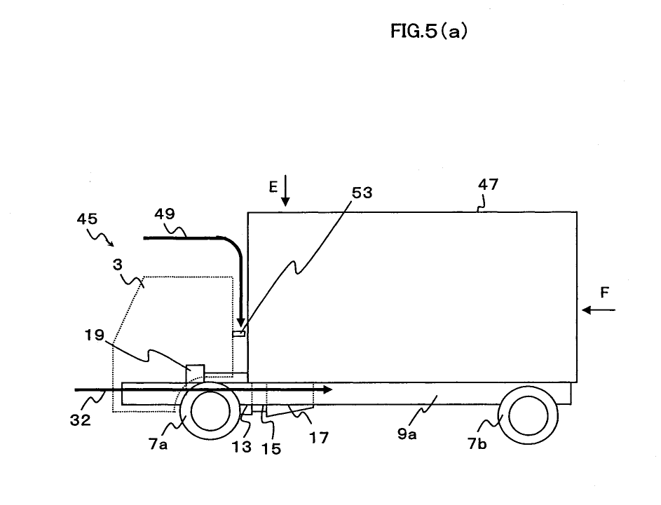

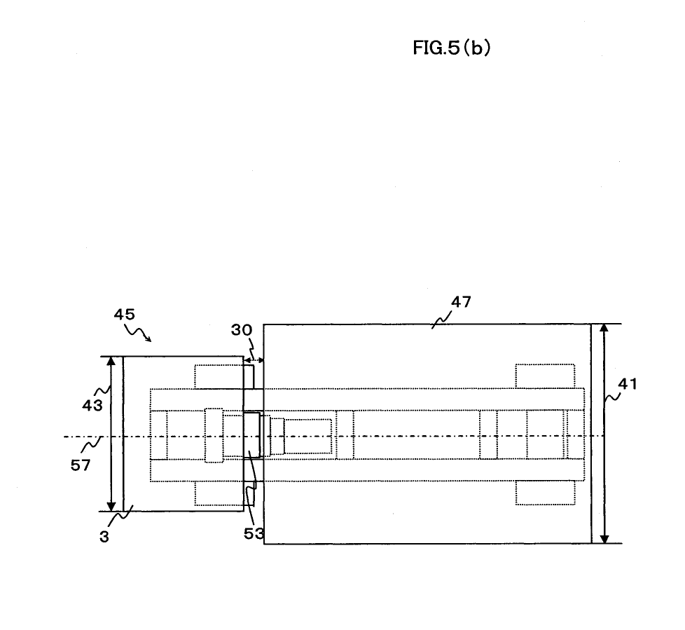

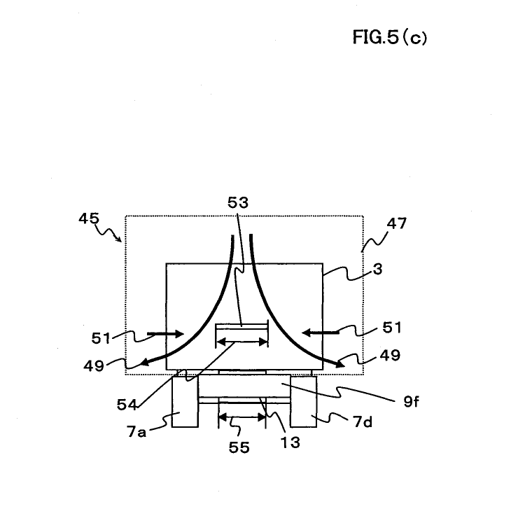

FIGS. 5(a), 5(b), and 5(c) show the truck 45 according to the second embodiment. FIG. 5(a) is a side view of the truck; FIG. 5(b) is a view of the truck as viewed in the direction of arrow E in FIG. 5(a); and FIG. 5(c) is a view of the truck as viewed in the direction of arrow F in FIG. 5(a). In FIGS. 5(a), 5(b), and 5(c), elements which provide the same functions as those in the truck 1 of the first embodiment are denoted by the same reference numerals, and their descriptions will not be repeated.

The truck 45 according to the second embodiment has a structure similar to that of the truck 1 according to the first embodiment; however, as shown in FIG. 5(b), the truck 45 is designed such that the van width 41 is greater than the cab width 43.

Further, as shown in FIG. 5(c), a width 54 of the windbreaking plate 53 is approximately equal to an engine width 55. By virtue of this configuration, as shown in FIG. 5(c), the flow direction of downward air flow 49 is changed in the width direction of the truck such that air flows through sides of the engine 13.

The downward air flow 49, which is caused by the windbreaking plate 53 to flow through the sides of the engine 13, prevents the side air flows 51 from hitting the engine 13, and prevents the pressure around the engine 13 from increasing, to thereby prevent a lowering of the performance of cooling the engine 13.

Further, because of the downward air flow 49, which flows through the sides of the engine 13, suction of the radiator intake air flow 32 occurs, whereby the quantity of air passing through the radiator 19 can be increased actively, and the performance of cooling the engine 13 is improved.

That is, it is possible to simultaneously realize an increase in the load capacity through an increase in the width of the van 47 and an improvement in the performance of cooling the engine 13 through prevention of pressure increase around the engine 13.

Notably, as shown in FIGS. 5(b) and 5(c), the windbreaking plate 53 is desirably disposed immediately above the engine 13 such that an engine center line 57, which is the center line of the engine 13 with respect to the width direction of the truck, coincides with the center of the windbreaking plate 53. However, in a case where such an arrangement is difficult in view of design, the windbreaking plate 53 may be provided at a position where a portion of the windbreaking plate 53 is located above the engine center line 57.

In the second embodiment, the windbreaking plate 53 is provided on the truck 45, and the width 54 of the windbreaking plate 53 is approximately equal to the engine width 55 as described above.

Accordingly, even in the truck 45 designed such that the van width 41 is greater than the cab width 43, the performance of cooling the engine 13 can be readily improved at low cost. Therefore, an engine of high output can be mounted.

Next, a third embodiment will be described.

In the above-described trucks, the engine is exposed to the gap between the cab and the van. However, in some trucks, not the engine but the drive-force transmission apparatus such as the transmission is exposed to the gap between the cab and the van.

In this case as well, a downward air flow hits the transmission to thereby increase the pressure in the vicinity of the transmission, so that the radiator intake air flow becomes difficult to pass through the vicinity of the transmission. In such a case, the quantity of air passing through the radiator decreases, and the cooling performance deteriorates. Therefore, measures similar to those in the case where the engine is exposed must be employed.

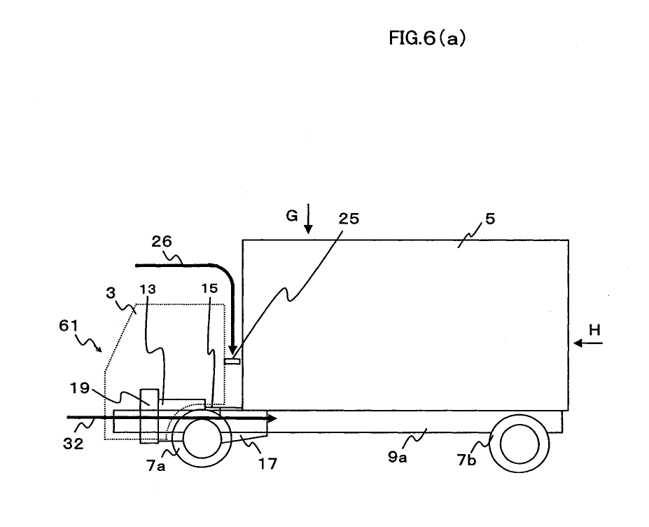

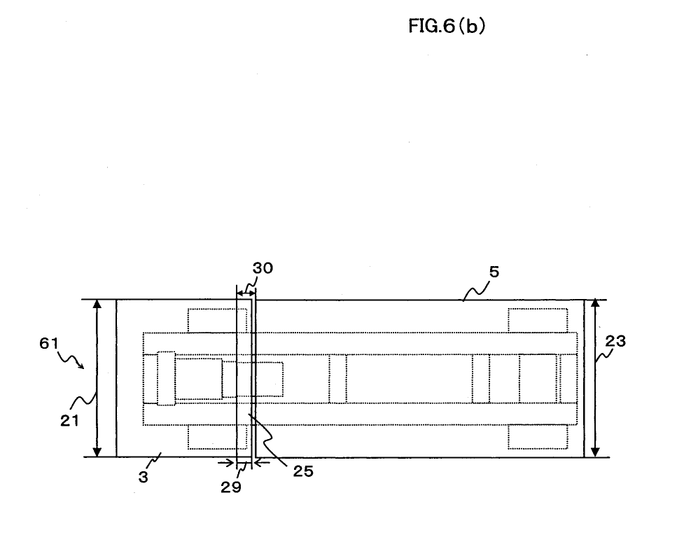

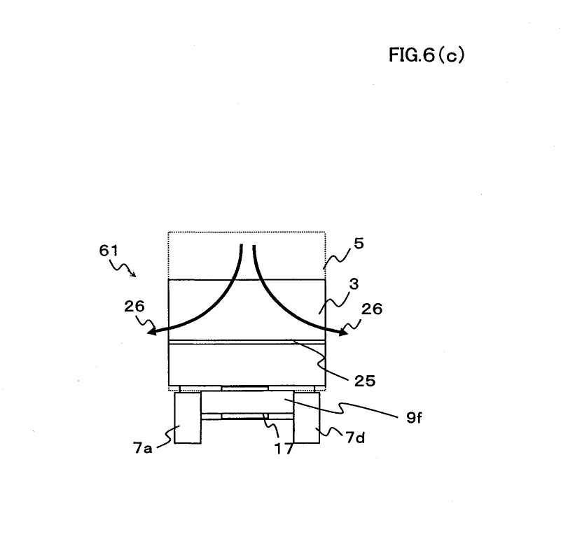

FIGS. 6(a), 6(b), and 6(c) show a truck 61 according to the third embodiment. FIG. 6(a) is a side view of the truck; FIG. 6(b) is a view of the truck as viewed in the direction of arrow G in FIG. 6(a); and FIG. 6(c) is a view of the truck as viewed in the direction of arrow H in FIG. 6(a). Notably, in FIGS. 6(a), 6(b), and 6(c), elements which provide the same functions as those in the truck 1 of the first embodiment are denoted by the same reference numerals, and their descriptions will not be repeated.

The truck of the third embodiment differs from the truck 1 of the first embodiment in that the transmission 17, rather than the engine 13, is exposed to the gap 30 between the cab 3 and the van 5.

As shown in FIGS. 6(a), 6(b), and 6(c), even when the transmission 17, rather than the engine 13, is exposed to the gap 30 between the cab 3 and the van 5, through provision of the windbreaking plate 25, the downward air flow 26 is prevented from hitting the transmission 17, and an increase in the pressure around the transmission 17 is prevented.

Accordingly, the radiator intake air flow 32 is improved, whereby decrease in the quantity of air passing through the radiator 19 can be suppressed.

In the third embodiment, since the windbreaking plate 25 is provided on the rear surface of the cab 3 as described above, even in the case where the transmission 17 is exposed to the gap between the van 3 and the cab 5, the performance of cooling the engine 13 can be readily improved at low cost. Therefore, an engine of high output can be mounted.

Next, a fourth embodiment will be described.

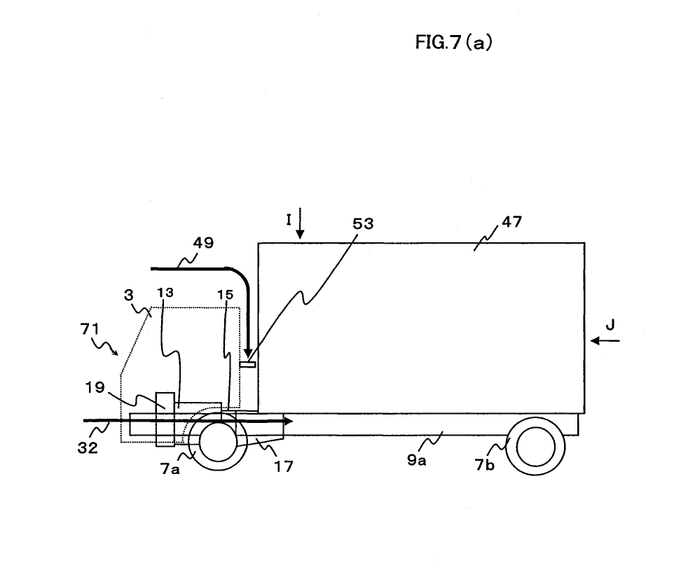

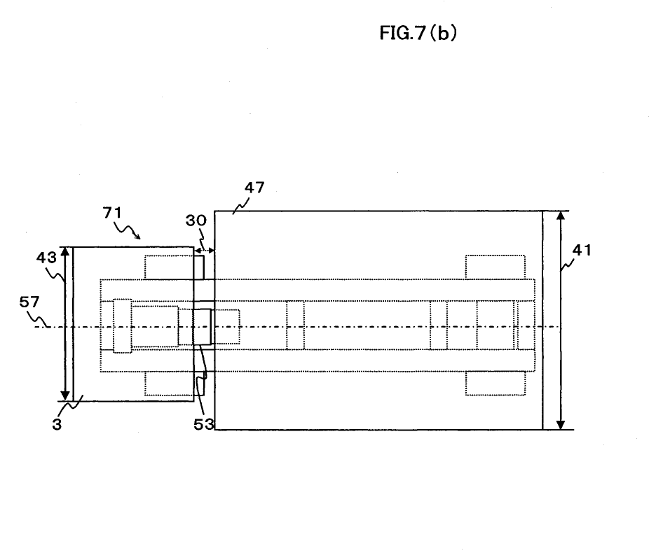

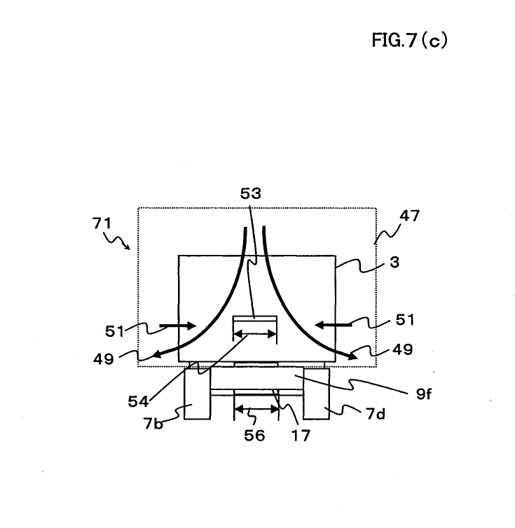

FIGS. 7(a), 7(b), and 7(c) show a truck 71 according to the fourth embodiment. FIG. 7(a) is a side view of the truck; FIG. 7(b) is a view of the truck as viewed in the direction of arrow I in FIG. 7(a); and FIG. 7(c) is a view of the truck as viewed in the direction of arrow J in FIG. 7(a). In FIGS. 7(a), 7(b), and 7(c), elements which provide the same functions as those in the truck 45 of the second embodiment are denoted by the same reference numerals, and their descriptions will not be repeated.

The truck 71 according to the fourth embodiment differs from the truck 45 according to the second embodiment in that the transmission 17 of the drive-force transmission apparatus, rather than the engine 13, is exposed to the gap between the cab 3 and the van 47.

As shown in FIGS. 7(a) and 7(b), even when the transmission 17, rather than the engine 13, is exposed to the gap 30 between the cab 3 and the van 47, through provision of the windbreaking plate 53, the downward air flow 49 is prevented from hitting the transmission 17, and an increase in the pressure around the transmission 17 is prevented.

Accordingly, the radiator intake air flow 32 is improved, whereby decrease in the quantity of air passing through the radiator 19 can be suppressed.

In addition, since the width of the windbreaking plate 53 is approximately equal to the width 56 of the transmission 17 as shown in FIG. 7(c), the flow direction of downward air flow 49 is changed in the width direction of the truck such that air flows through sides of the transmission 17.

The downward air flow 49, which is caused by the windbreaking plate 53 to flow through the sides of the transmission 17, prevents the side air flows 51 from hitting the transmission 17, and prevents the pressure around the transmission 17 from increasing, to thereby prevent a lowering of the performance of cooling the engine 13. Further, because of the downward air flow 49, which flows through the sides of the transmission 17, suction of the radiator intake air flow 32 occurs, whereby the quantity of air passing through the radiator 19 can be increased actively, and the performance of cooling the engine 13 is improved.

That is, it is possible to simultaneously realize an increase in the load capacity through an increase in the width of the van 47 and an improvement in the performance of cooling the engine 13 through prevention of pressure increase around the transmission 17.

In the fourth embodiment, the windbreaking plate 53 is provided on the truck 71, and the width 54 of the windbreaking plate 53 is approximately equal to the width 56 of the transmission 17 as described above.

Accordingly, even in the truck 71 designed such that the transmission 17 is exposed from the gap 30 between the van 47 and the cab 5 and the van width 41 is greater than the cab width 43, the performance of cooling the engine 13 can be readily improved at low cost. Therefore, an engine of high output can be mounted.

Here, the shapes of the windbreaking plates 25 and 53 used in the first through fourth embodiments will be described.

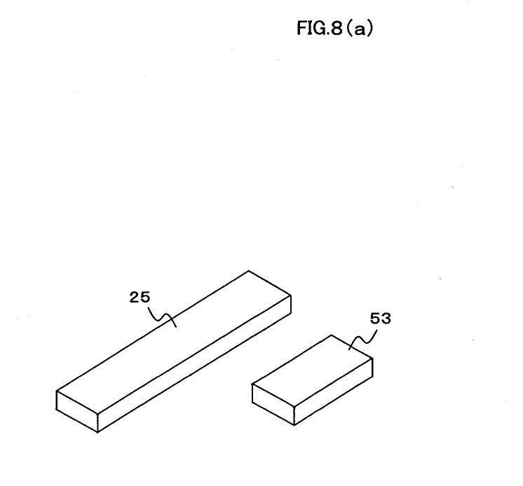

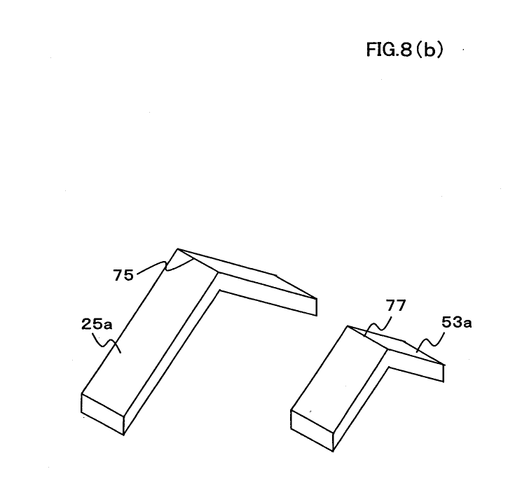

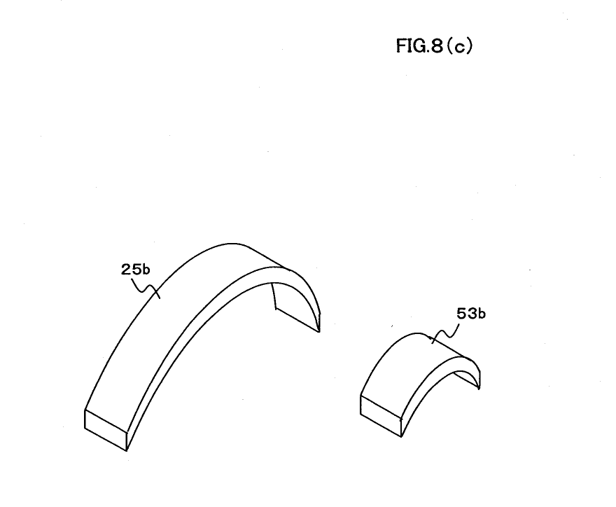

FIGS. 8(a), 8(b), and 8(c) are views showing various shapes of the windbreaking plates 25 and 53. FIG. 8(a) shows an ordinary shape, and FIGS. 8(b) and 8(c) show modifications of the shape of FIG. 8(a).

As shown in FIGS. 8(a), 8(b), and 8(c), each of the windbreaking plates 25, 25a, 25b, 53, 53a, and 53b assumes a plate-like shape extending in the horizontal direction.

Since the windbreaking plate 25 (53) assumes a plate-like shape extending horizontally, it diverges the downward air flow 26 (49) flowing through the gap 30 between the cab 3 and the van 5 (47) to the sides of the cab 3 to thereby prevent an increase in pressure, which would otherwise occur at the downstream side of the radiator intake air flow 32 passing through the radiator 19. Therefore, the air having passed through the radiator 19 can be discharged effectively to the width direction of the truck or the lower side of the truck, whereby an excellent cooling performance can be exhibited.

The windbreaking plate 25 (53) may assume a bent shape to be upwardly convex as in the case of the windbreaking plate 25a (53a) shown in FIG. 8(b) or a curved shape to be upwardly convex as in the case of the windbreaking plate 25b (53b) shown in FIG. 8(c).

Notably, when the windbreaking plate 25a or 53a is attached to the cab 3, the windbreaking plate 25a or 53a is desirably attached at a location where a top line 75 or 77 coincides with the engine center line 57.

Preferred embodiments of the present invention have been described with reference to the accompanying drawings. However, the technical scope of the present invention is limited to the above-described embodiments. It is clear that a person skilled in the art can conceive various changes and modifications within the technical idea described in the claims, and they naturally fall within the technical scope of the present invention.

For example, in the embodiments, the windbreaking plate 25 or 53 is attached to the cab 3; however, the windbreaking plate 25 or 53 may be attached to the van 5 or 47.

1. A truck characterized by comprising:
a load container provided rearward of a cab and projecting upward from the cab;
an engine provided under the cab;
a radiator provided forward of the engine; and
a windbreaking section provided between the cab and the load container.

2. A truck according to claim 1, wherein
the load container is formed to have a width equal to or smaller than that of the cab, and
the windbreaking section is provided above the engine and formed to extend over a width approximately equal to the width of the cab.

3. A truck according to claim 1, wherein
the load container is formed to have a width greater than that of the cab, and
the windbreaking section is provided above the engine across a center line of the engine with respect to a width direction of the truck and formed to extend over a width approximately equal to the width of the engine.

4. A truck characterized by comprising:
a load container provided rearward of a cab and projecting upward from the cab;
an engine provided under the cab;
a radiator provided forward of the engine;
a drive-force transmission apparatus provided rearward of the engine; and
a windbreaking section provided between the cab and the load container.

5. A truck according to claim 4, wherein
the load container is formed to have a width equal to or smaller than that of the cab, and
the windbreaking section is provided above the drive-force transmission apparatus and formed to extend over a width approximately equal to the width of the cab.

6. A truck according to claim 4, wherein
the load container is formed to have a width greater than that of the cab, and
the windbreaking section is provided above the drive-force transmission apparatus across a center line of the drive-force transmission apparatus with respect to a width direction of the truck and formed to extend over a width approximately equal to the width of the drive-force transmission apparatus.

7. A truck according to claim 1, wherein the windbreaking section assumes a plate-like shape generally extending horizontally.

8. A truck according to claim 7, wherein the plate-shaped windbreaking section assumes the form of a flat plate horizontally extending in a width direction of the cab.

9. A truck according to claim 7, wherein the plate-shaped windbreaking section is bent such that the windbreaking section is upwardly convex at a central portion thereof in the width direction of the cab.

10. A truck according to claim 7, wherein the plate-shaped windbreaking section is curved such that the windbreaking section is upwardly convex.

11. A truck according to claim 4, wherein the windbreaking section assumes a plate-like shape generally extending horizontally.

12. A truck according to claim 11, wherein the plate-shaped windbreaking section assumes the form of a flat plate horizontally extending in a width direction of the cab.

13. A truck according to claim 11, wherein the plate-shaped windbreaking section is bent such that the windbreaking section is upwardly convex at a central portion thereof in the width direction of the cab.

14. A truck according to claim 11, wherein the plate-shaped windbreaking section is curved such that the windbreaking section is upwardly convex.
